(19) United States
(12) Patent Application Publication
(10) Pub. No.: US 2026/0112925 A1
(43) Pub. Date: Apr. 23, 2026

(54) NEWTON'S THIRD LAW PROPELLANTLESS PROPULSION SYSTEM

(71) Applicant: Haroldo Ariel Tavarez, Downey, CA (US)

(72) Inventor: Haroldo Ariel Tavarez, Downey, CA (US)

(21) Appl. No.: 18/831,295

(22) Filed: Oct. 18, 2024

(51) Int. Cl. H02K 1/16; H02K 1/17; H02K 1/2706; H02K 11/20

(52) U.S. Cl. CPC H02K 1/16; H02K 1/17; H02K 1/2706; H02K 11/20

(57) ABSTRACT

A propulsion system that generates propellantless thrust with the Newton's Third Law action and reaction; by way of magnetic field interactions between the magnetic fields of one or more rotors interacting with the magnetic fields of one or more stators, involving: A first magnetic field sector comprising one or more stators; generating a first magnetic field of increasing magnetic field intensity to accelerate one or more rotors with magnetic field attraction. A second magnetic field sector comprising one or more stators generating a second magnetic field of decreasing magnetic field intensity, to decelerate one or more rotors with magnetic field repulsion. The accelerations and decelerations of one or more rotors; is the Newton's Third Law action that generate, the reciprocal equal and opposite Newton's Third Law reaction in one or more stators. The vector sum of all the reaction forces in the stators; combine to make a propulsive Newton's Third Law reaction force, without the ejection of mass propellant and without reliance on an external mass to react against.

### CROSS-REFERENCE TO RELATED APPLICATIONS

### FEDERALLY SPONSORED RESEARCH Not Applicable

### SEQUENCE LISTING OR PROGRAM Not applicable

### BACKGROUND—FIELD

This application relates to a propulsion system that generates propellantless thrust with the Newton's Third Law action and reaction by way of magnetic fields action and reaction.

### BACKGROUND—PRIOR ART

Propulsion on land, water, air, and in the vacuum of space; depends on propellant. The present propulsion technology; is based on Newton's Third Law of action and reaction that says, “For every action there is an equal and opposite reaction”. Each of these modes of transportation requires a given and specific type of propellant dependent propulsion system. Accordingly, the current propulsion technology is completely dependent on the Newton's Third Law of action and reaction with propellant.

On the ground, a land driven motor vehicle with an electric motor or an internal combustion engine; deliver the torque to drive the motor vehicle wheels. The ground in contact with the wheels is the propellant.

In aerospace, for propellant; gas turbine engines use the air and the fuel to heat the air, and at the same time, pollute the atmosphere with the exhaust. Propellers use air and water for propellant. Rocket engines, while useful for air and space travel; have limited propulsion capabilities due to the reliance on propellant for propulsion in the atmosphere and in the vacuum of space. While in flight through the air, the rocket's exhaust also pollutes the atmosphere with the dangerous and harmful exhaust.

Practical propulsion systems that generates thrust without propellant for on land, water, air, space travel, and for satellites in orbit; are not yet available; but not for the lack of trying by the workers in the field. Consequently, all of the current propulsion systems available; have the limitations imposed by reliance on propellant.

The solution to eliminate the propellant; is a new propulsion technology based on the Newton's Third Law of action and reaction without propellant. The disclosed prime mover; is a practical and efficient propulsion system that converts electricity and the forces in magnetic fields to propellantless thrust. All in accordance with the principles rooted in the Newton's Third Law of action in combination with the consequential equal and opposite reaction.

### SUMMARY

The disclosed propulsion system is a novel prime mover that generates thrust with the Newton's Third Law of motion consisting of action and reaction; by way of the forces of magnetic field attraction and magnetic field repulsion. The Newton's Third Law action component applied as a magnetic field action; generates a consequential Newton's Third Law magnetic field reaction, in an exchange of magnetic field interactions involving the magnetic fields of one or more stators interacting with the magnetic fields of one or more rotors.

A basic propulsion system comprises an annular housing with one or more stators in a sector angularly disposed adjacent to the housing; with one or more rotors in motion in a clockwise or counterclockwise direction inside an annular track inside the housing. One or more stators generate; one or more magnetic fields to accelerate one or more rotors with the forces of magnetic field attraction to produce; localized Newton's Third Law reaction forces in the stators. A second sector of a predetermined angular length allows for the return of one or more rotors to the first sector. The Newton's Third Law reaction forces in the stators generate a propulsive and directional Newton's Third Law reaction force.

An improved propulsion system comprises: An annular housing with a plurality of magnetic field generating stators disposed in two angular sectors around the housing; with one or more rotors moving inside an annular track inside the housing. A first magnetic field sector with one or more stators; accelerate one or more rotors with magnetic attraction. A second magnetic field sector with one or more stators; decelerate one or more rotors with the force of magnetic repulsion. The rotors accelerations and decelerations generate localized Newton's Third Law reaction forces on the stators in each sector. The stators reaction forces comprise the resultant directional and propulsive Newton's Third Law reaction force.

The stators are organized to occupy two circumferential sectors of predetermined angular length. In the first sector, one or more stators providing a first magnetic field of increasing magnetic field intensity in the counterclockwise direction; accelerate one or more rotors in the direction of increasing magnetic field intensity. The accelerations of one or more rotors; generate Newton's Third Law reaction forces in the stators in the first sector.

The second sector is a return pathway that allows one or more rotors to go back to the first sector. With magnetic fields generating stators included, the second sector becomes a second magnetic field sector comprising; one or more stators providing a second magnetic field of decreasing magnetic field intensity in the counterclockwise direction. The second magnetic field decelerates one or more rotors in the direction of decreasing magnetic field intensity. The rotor decelerations can be implemented with magnetic attraction or magnetic repulsion.

Inside the housing there are; one or more slidable rotors of predetermined magnetic properties, dimensions, mass, size, and shape; for ease of movement inside an internal channel fashioning an annular track. The rotor in the track moves at predetermined angular velocities; driven by the forces of magnetic field attraction and magnetic field repulsion between the rotor and the stator magnetic fields. The magnetic field interactions between the magnetic fields of one or more rotors interacting with the magnetic fields of one or more stators; is the Newton's Third Law action that generate in the stator a corresponding Newton's Third Law equal and opposite reaction. The Newton's Third Law reaction in one or more stators generate; thrust without propellant ejection and without dependence on an external mass to react against.

To generate thrust, the magnetic field action at a distance interaction between the rotor and the stator; accelerate and decelerated the rotor in order to generate; the corresponding Newton's Third Law reaction in the stator. The Newton's Third Law action; is the magnetic field attraction or the magnetic field repulsion of the rotor by the stator. By applying on the rotor, the magnetic forces of attraction with a predetermined magnetic field intensity and duration; the stator magnetically attracts and accelerate the rotor; and at the same time generate, the reciprocal equal and opposite Newton's Third Law reaction in the stator.

Similarly, the magnetic field repulsion between the rotor magnetic field and the stator magnetic field; is also a Newton's Third Law action. The stator magnetic field in front of an oncoming rotor magnetically repels the rotor away from the stator by resisting the approach. The magnetic field repulsion between the rotor and the stator; decelerate the rotor. And at the same time, the magnetic field repulsion between the rotor and the stator; generates the corresponding and reciprocal equal and opposite Newton's Third Law reaction in the stator.

By applying on the rotor the forces of magnetic field attraction and magnetic field repulsion with a predetermined magnetic field intensity and duration; the stator can magnetically attracts and accelerate the rotor, or magnetically repel and decelerate the rotor. With the magnetic field forces of attraction and repulsion, the stator can accelerate or decelerate one or more rotors to any predetermined angular velocity to generate Newton's Third Law reaction forces in the stator.

Magnetic field action on the rotor; generates the corresponding Newton's Third Law equal and opposite reaction in the stator. With magnetic attraction, the stator magnetic field action at a distance on the rotor; sets in motion the rotor movement toward the stator and at the same time generate, the reciprocal equal and opposite Newton's Third Law reaction.

Similarly, the magnetic field action on the rotor with the stator magnetic forces of repulsion; repels and push the speeding rotor away from the stator. And at the same time; generates the equivalent Newton's Third Law equal and opposite reaction in the stator. The Newton's Third Law reaction in the stator; generate consequential and significant forces in the system.

The vector sum of all the reaction forces of one or more rotors interacting magnetically with one or more stators; determines the resultant reaction force magnitude and direction. In this fashion, the symbiotic relationship between the Newton's Third Law action and the reaction; generates a net propulsive reaction force without the ejection of a mass of propellant and without reliance on an external mass to react against.

### BRIEF DESCRIPTION OF THE DRAWINGS

FIG. 1 shows a propulsion system comprising an annular housing with a plurality of stators.

FIG. 2 shows a front view of the propulsion system in FIG. 1.

FIG. 3 is a view taken along the line A-A′ in FIG. 2.

FIG. 4 is a sectional view taken along the line B-B′ in FIG. 3.

FIG. 5 shows an improved propulsion system comprising two stator assemblies in two sectors.

FIG. 6 is a front view of the propulsion system shown in FIG. 5.

FIG. 7 is a view taken along the line C-C′ in FIG. 6.

FIG. 8 is an improved version of the propulsion system shown in FIG. 5

FIG. 9 is a front view of the propulsion system in FIG. 8.

FIG. 10 shows an internal view taken along the line D-D′ in FIG. 9.

FIG. 11 shows an improved version of the propulsion system shown in FIG. 10.

FIG. 12 is the propulsion system in FIG. 11 with a shift in propulsion force direction.

FIG. 13 shows the reaction vector force components in a single magnetic field sector, and the resultant Newton's Third Law propellantless reaction force produced.

FIG. 14 shows the local reaction vector force components in the first magnetic field sector, the local reaction forces in the second magnetic field sector, and the resultant Newton's Third Law propellantless reaction force.

FIG. 15 illustrates an operational derivative of the propulsion system shown in FIG. 10 with a select number of stators in operation.

### DETAILED DESCRIPTION OF PREFERRED EMBODIMENTS

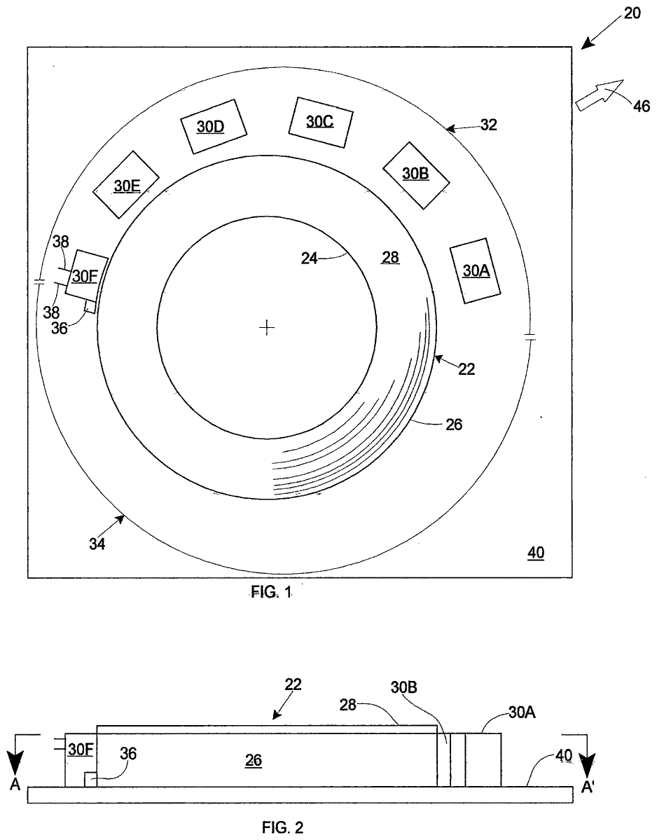

### FIGS. 1, 2, 3 and FIG. 4—First Embodiment

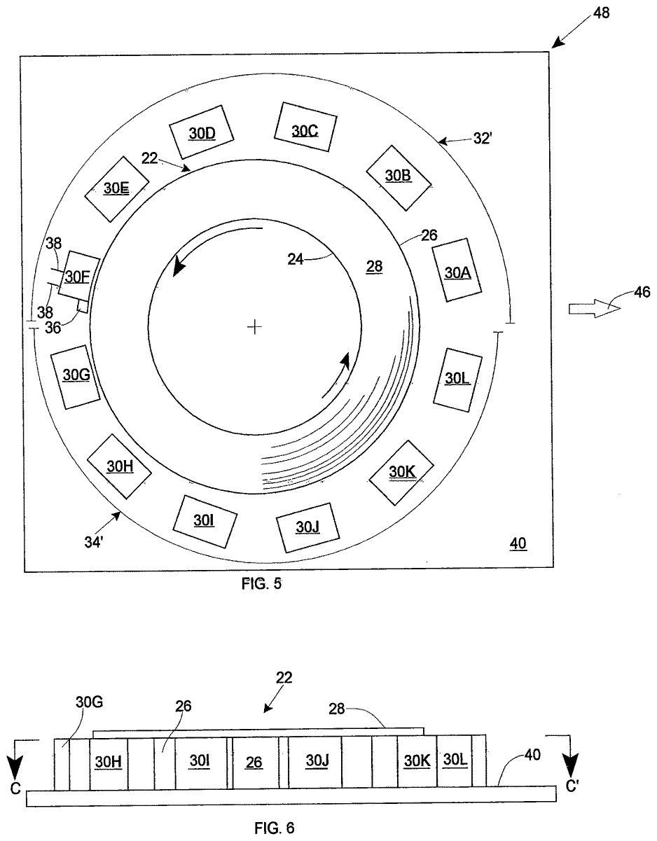

FIGS. 1-4 show a basic propulsion system 20 with an annular housing 22, a housing inner wall 24, a housing outer wall 26, a housing cover 28, a plurality of stators 30A-30F, a magnetic field sector 32, a second sector 34, a sensor 36 attached to the stator 30F, electric wires 38 for connection to a power supply (not shown), a frame 40, an annular track 42 with one or more rotors 44 in the track 42 (best seen in FIG. 3), and a Newton's Third Law reaction force 46. The propulsion system 20 demonstrates; the basic and fundamental thrust output operation that generates; propellantless thrust with the Newton's Third Law action and reaction by way of magnetic fields interactions.

### FIG. 1

FIG. 1 shows the stators 30A-30F angularly spaced at predetermined angular intervals, adjacent to but spaced apart from the housing 22. The stators 30A-30F, when viewed in the clockwise direction; are disposed at increasing distances away from the periphery of the housing outer wall 26. The magnetic field sector 32 comprising the stators 30A-30F; provide a magnetic field of increasing magnetic field intensity in the counterclockwise direction; wherein the magnetic field is continuous, except in the stator 30F. During operation, the stator 30F briefly de-energizes to create a magnetic field break; that allows the rotor 44 to escape from the stator 30F magnetic field zone; in order to continue in transit toward the second sector 34. The second sector 34 is without stators. The magnetic field sector 32 length is approximately 180° or less.

In the propulsion system 20, the stators 30A-30E; are permanent magnets (Neodymium). The stator 30F is an electromagnet with a sensor 36 to detect the rotor 44 presence in the track 42 in the housing 22 (best seen in FIG. 3). The stator 30F receives electric power from an electric power supply (not shown) to generate a magnetic field of a predetermined magnetic intensity when energized. The stator 30F is the closest stator to the housing outer wall 26 (including a position adjoining the wall 26). The housing 22 and the cover 28 are made of non-magnetic materials. The housing 22 and the stators 30A-30F are affixed on the frame 40.

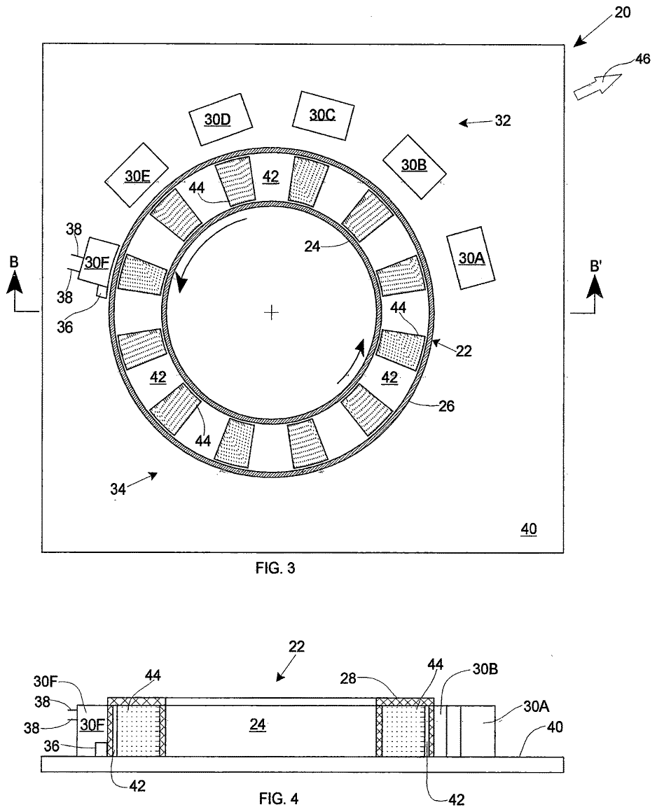

### FIG. 2

FIG. 2 is a side view of the propulsion system 20; showing the annular housing 22, the housing outer wall 26, the housing cover 28, a partial view of the stator 30A, 30B, and the stator 30F,

### FIG. 3

FIG. 3 shows a view of the annular housing 22 taken along the line A-A′ in FIG. 2; showing the housing 22, housing inner wall 24, housing outer wall 26, the magnetic field sector 32 with the stators 30A-30F and the second sector 34 without stators. The stator 30F has a sensor 36 with electric wires 38 for connection to a power supply (not shown), the frame 40, the track 42 with multiple rotors 44 inside, and the consequential Newton's Third law reaction force 46.

FIG. 3 shows the magnetic field sector 32 with one or more stators 30A-30F angularly disposed, angularly spaced, adjacent to but apart from the housing 22 at increasing distances from the housing outer wall 26, when viewed in the clockwise direction. In the magnetic field sector 32, the stators 30A-30F provide a continuous magnetic field of increasing magnetic field intensity in a counterclockwise direction; except in the stator 30F at a predetermined moment when the electromagnet stator 30F de-energizes and turns off to stop producing its magnetic field.

In the magnetic field sector 32, the stator 30F is adjacent to or in the position closest to the housing outer wall 26 periphery (including touching). The stator 30F is an electrically active electromagnet that generates a magnetic field that briefly turns off to create a magnetic field break that allows the rotor 44 in its proximity to move forward toward the second sector 34.

The second sector 34 is a sector without stators comprising a predetermined segment of the track 42 with a predetermined angular length; to allow the traffic of rotors 44 to continue in transit to return and go back to the magnetic field sector 32, in order to start another Newton's Third Law reaction 46 thrust output cycle all over again.

Inside the housing 22, the traffic of one or more rotors 44 inside the track 42 move with an accelerated first angular velocity while in transit through the magnetic field sector 32. Upon the arrival of any rotor 44 to the vicinity of the stator 30F, the detection of the rotor 44 by the sensor 36; signal the stator 30F to de-energize momentarily to allow the rotor 44 to pass and move away from the stator 30F toward the second sector 34.

The rotor 44 has the proper curvature, shape, and dimensions to allow the rotor 42 to slide and move with ease inside the track 42. The rotor 44 can be an implementation with permanent magnets like Neodymium magnets; or electromagnets with the required electric circuits and electric components included in the annular housing 22 to support the electric rotor 44 operation in the track 42.

The stator 30E includes internal electronic circuit boards that cooperate with the sensor 36 to detect the rotor 44 in the track 42, in order to energize and de-energize the electromagnet stator 30F at the proper instant so as to engage and disengage magnetically with the rotor 44 with the proper timing. One or more rotors 44 reside internally inside the annular housing 22; in the channeled space that define the annular track 42. Inside the housing 22; the rotor 44 movement is in the counterclockwise direction with the angular velocity attained with the

### FIG. 4

accelerations driven by the magnetic field interactions with the stators 30A-30F in the magnetic field sector 32. In the second sector 34, the traffic of one or more rotors 44 in transit in the track 42; travel through the sector 34 toward the magnetic field sector 32 to start another Newton's Third Law reaction thrust output cycle.

FIG. 4 is a front cross sectional view along B-B′ in FIG. 3; showing the housing 22 with two rotors 44, stator 30A, stator 30B, and the stator 30F with electric wires 38 for connection to the power supply (not shown), housing cover 28, housing inner wall 24, and the frame 40.

The sensor 36 as part of the stator 30F can be either, a mechanical sensor, proximity sensor, an optical sensor, a motion sensor, a pressure sensor, Hall Effect sensors, or any other type of suitable sensor technology as currently known. In addition to alongside the stator 36, the sensor 36 can be located in any other appropriate location on the housing 22.

Even though FIG. 4 shows the housing 22 cross section as rectangular; the housing 22 can also be construed with circular, square, polygonal or any other applicable cross sectional shape.

### OPERATION—FIG. 3—First Embodiment

The propulsion system 20 operation that generates the Newton's Third Law reaction force 46 is best described with FIG. 3. To demonstrate how the Newton's Third Law action and reaction; generate propellantless propulsion via the forces inherent in magnetic fields.

In the descriptions that follow, the term stator is used in the sense meaning, a source or sources of magnetic fields involving; permanent magnets and electromagnets to provide the interacting magnetic fields that produce the forces of magnetic field attraction, and the forces of magnetic field repulsion typical in the fields. A sector is a zone or a segment of the housing 22 and the track 42 having a predetermined angular length (180° or less); in addition to a predetermined angular position around the housing 22. Like numbers refer to like components throughout the specification.

In the magnetic field sector 32, the stators 30A-30F magnetic fields combine as a magnetic field of increasing magnetic field intensity in the counterclockwise direction. The magnetic field polarity of the stators 30A-30F magnetic field is opposite to the rotor 44 magnetic field polarity. The opposing polarities between the stators 30A-30F and the rotors 44; generates magnetic field attraction forces between the stators 30A-30F and the rotors 44. In the magnetic field sector 32; the magnetic field interactions between one or more rotors 44 and the stators 30A-30F are in the magnetic attraction mode.

To generate Newton's Third Law reactions in the magnetic field sector 32, the increasing magnetic field forces of attraction in the counterclockwise direction; accelerate one or more rotors 44 to a predetermined angular velocity in the counterclockwise direction. The magnetic attraction forces from the stators 30A-30F increasing magnetic field; is the Newton's Third Law action that accelerates one or more rotors 44 in the track 42.

Simultaneously, the Newton's Third Law action from the stators 30A-30F magnetic field that accelerate one or more rotors 44; generate a reciprocal equal and opposite Newton's Third Law reaction in the stators 30A-30F. The stators 30A-30F Newton's Third Law magnetic field action that accelerate the rotors 44 in the counterclockwise direction; generate in the stators 30A-30F, the reciprocal equal and opposite Newton's Third Law reaction in the opposite clockwise direction.

Upon the rotor 44 arrival to the stator 30F, the sensor 36 detects the rotor 44 and turns off its magnetic field temporarily for a predetermined period of time to make a magnetic field break that allow the rotor 44 to pass and continue in transit toward the second sector 34. Without the break, the rotor 44 would stop instead of moving forward through the sector 32 toward the stator 30A. The rotor 44 acceleration in the sector 32; endows the rotor 44 with angular velocity, energy of motion, and a predetermined angular momentum that allows the rotor 44 to continue in transit toward the second sector 34.

In the second sector 34, each rotor 44 decelerates while passing through the second sector 34 in transit to go back and return to the magnetic field sector 32. Upon arrival to the sector 32 first stator 30A; the rotor 44 initiate another Newton's Third Law reaction thrust output cycle by coming in contact with the stator 30A magnetic field.

In the propulsion system 20, the stators 30A-30F; are situated in different angular positions on the housing 22. The corresponding Newton's Third Law reactions on the stators 30A-30F; are also angularly disposed at an angle of inclination that correspond to the particular stator 30A-30F generating the reaction force. Accordingly, the resultant reaction forces in the stators 30A-30F; generate reaction vector force components. The vector sum of all the reaction vector force components in the magnetic field sector 32 comprises the totality of the magnitude and direction in the propulsive Newton's Third Law reaction force 46.

In the system 20, the stators 30A-30E; are permanent magnets. The stator 30F comprises an electromagnet with internal electronic circuit boards that cooperates with the corresponding sensor 36 to detect the rotor 44 in the track 42. The stator 30F generates a magnetic field that attracts the rotor 44. Upon the rotor 44 detection, the stator 30F de-energizes momentarily to provide the required magnetic field break that allows the traffic of rotors 44; to continue moving forward in transit toward the second sector 34 toward the stator 30A. In the stator 30A at the beginning of the magnetic field sector 32, the rotor(s) 44; starts a new magnetic field interaction cycle with the stators 30A-30F magnetic field providing the increasing magnetic field attraction forces in the counterclockwise direction.

FIG. 3 shows the propulsion system 20 with six (6) stators 30A-30F, and twelve (12) rotors 44 in the track 42. A propulsion system can contain one or more rotors 44, with two or more magnetic field generating stators. The permanent magnets stators 30A-30E can be replaced with a single permanent magnet stator with the proper curvature and shape to generate the required and increasing magnetic field in the counterclockwise direction.

The stators 30A-30F are affixed to the frame 40 and the resultant Newton's Third Law reaction forces on the stators 30A-30F are communicated to the frame 40. And because the Newton's Third Law reaction forces on each of the stators 30A-30F are local reaction forces that merge as the propulsive Newton's Third Law reaction force 46, the frame 40 together with the housing 22 and the stators 30A-30F attached to the frame 40; will move in the direction of the reaction force 46. Therefore, by attaching the frame 40 to any vehicle, the vehicle will be propelled in the direction of the directional Newton's Third Law propulsive reaction force 46.

In the propulsion system 20, for each corresponding rotor 44; one propellantless thrust cycle constitutes; one acceleration cycle on which the rotor 44 interact magnetically with the stators 30A-30F, to augment the rotor 44 angular momentum, kinetic energy of motion, and the rotors 44 angular velocity in the track 42. And one deceleration cycle while in transit through the second sector 34.

### Newtonian Propellantless Propulsion

Newton's laws of motion linking energy and momentum conservation; are the fundamental principles that define the operations that take place in all propulsion engines. The operation that generates the propellantless forces that generate the thrust in the propulsion system 20, as well as in all known propulsion engines; is the Newton's Third Law of motion comprising the full application of the action and the reaction components of Newton's Third Law.

### Newton's Second Law Of Motion

Newton's second law of motion says: Force (F) is equal to the mass (m) times the acceleration (a), F=ma. In accordance with the second law, in the propulsion system 20, “m” is the mass of the rotor 44, “a” is the rotor 44 acceleration, and “F” is the force of the magnetic field that accelerates or decelerates the rotor 44. The magnitude of the magnetic field attraction force from each of the stators 30A-30F; is the magnetic field action that maintain, accelerate, and increase each and all the rotors 44 angular velocities. The magnitude of the rotor 44 acceleration and the resultant angular velocity and angular momentum that can be achieved; depends on the magnitude of the magnetic field attraction force the stators 30A-30F magnetic field apply to accelerate the rotor 44; in accordance with Newton's Second Law of motion.

### Newton's Third Law

The Newton's Third Law generates reaction and thrust by way of the magnetic field action on the rotor 44 that simultaneously generates the reciprocal equal and opposite Newton's Third Law reaction in the stators 30A-30F. The Newton's Third Law reaction in the stators 30A-30F; is the byproduct of the stators. 30A-30F magnetic field action in the form of the magnetic attraction force on the rotor 44. The stators 30A-30F magnetic field action; accelerates the rotors 44 toward the stators 30A-30F emitting the magnetic fields that merge as the increasing magnetic field in the counterclockwise direction. The propulsion system 20; generates thrust with the forces of magnetic attraction between one or more stators 30A-30F and one or more rotors 44.

In the magnetic field sector 32, the stators 30A-30F magnetic fields combine as a magnetic field of increasing magnetic field intensity in the counterclockwise direction. The magnetic field action on one or more rotors 44 receiving the magnetic field; generate a corresponding equal and opposite Newton's Third Law reaction in the stators 30A-30F. The rotor(s) 44 accelerate in the counterclockwise direction; and the resultant Newton's Third Law equal and opposite reaction on the stators 30A-30F; is in the opposite clockwise direction. The magnetic field action adds velocity, angular momentum, and energy of motion to the rotor 44.

When any rotor 44 reaches the energized electromagnet stator 30F, the sensor 36 detects the rotor 44, and de-energizes the stator 30F momentarily. In order to produce the magnetic field break that allows the rotor 44 to travel beyond the stator 30F, in order to continue forward in transit toward the second sector 34. After the rotor 44 moves away, the stator 30F; energizes once again and generate the magnetic field that attract the next oncoming rotor 44.

The action of the magnetic field forces of attraction from the stator 30A-30F on one or more rotors 44; is the Newton's Third Law action that accelerates the rotors 44. And at the same time, generate the required and consequent Newton's Third Law reaction that generates in the stators 30A-30F; the Newton's Third Law reaction vector force components that comprise the propellantless Newton's Third Law reaction force 46, produced without the ejection of mass propellant and without reliance on an external mass to react against.

### Newton's First Law Of Motion

Newton's First Law says: A body at rest or a body in motion will continue at rest or in motion unless acted upon by an external force. After the stator 30F de-energizes, with the acquired angular momentum, angular velocity, and kinetic energy of motion in the magnetic field sector 32; the traffic of one or more rotors 44 in the track 42, continues forward in motion in transit through the second sector 34 toward the magnetic field sector 32, to start a new propulsion cycle that begins in the stator 30A.

The operation of the propulsion system 20 demonstrates; a propellantless thrust output cycle produced with the full implementation of the Newton's Third Law of motion.

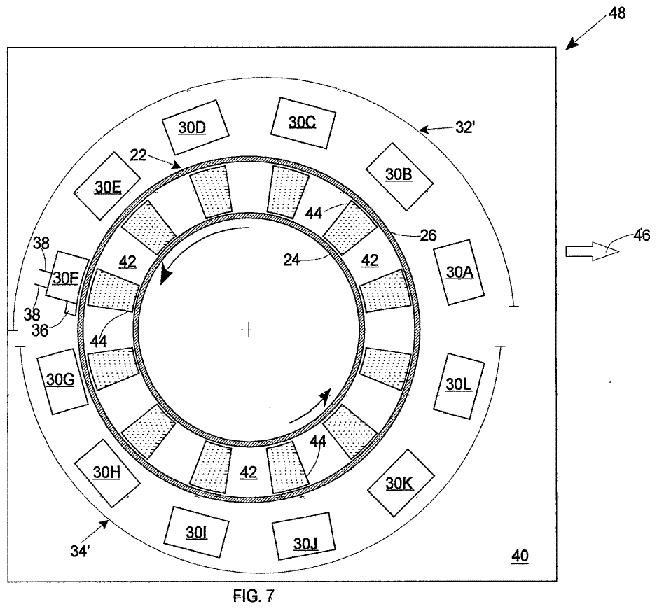

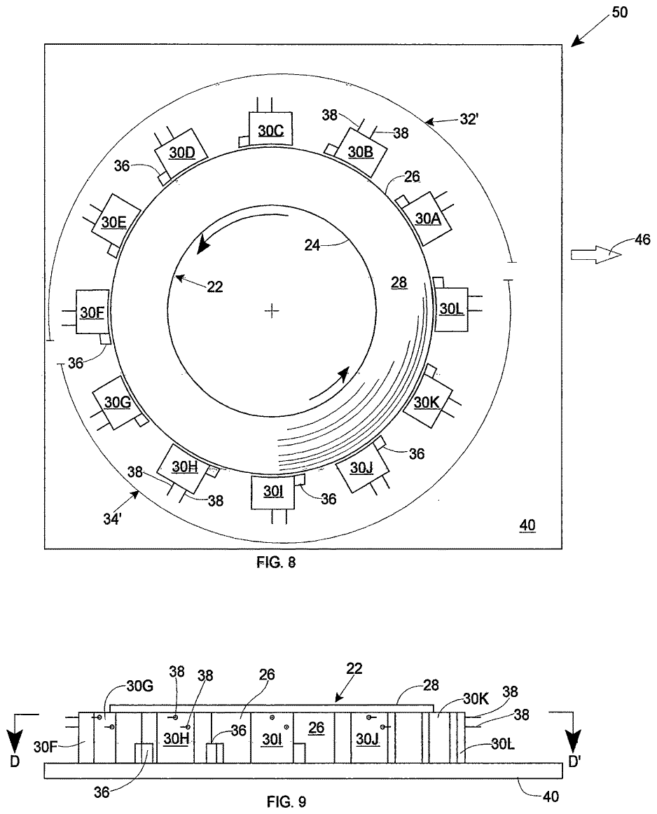

### FIG. 5, FIG. 6 and FIG. 7—Second Embodiment

### FIG. 5

FIG. 5 shows a propulsion system 48 as the improved propulsion system 20. The improvements are; the magnetic field sector 32 as a first magnetic field sector 32′, the addition of the stators 30G-30L to the second sector 34 as an improved second magnetic field sector 34′ with permanent magnets. The stator can be Neodymium magnets.

FIG. 5 shows the annular housing 22, housing inner wall 24, the housing outer wall 26, the housing cover 28, and the stators 30A-30F comprising the first magnetic field sector 32′. A second magnetic field sector 34′ with a second assembly of stators 30G-30L with permanent magnets, the frame 40, and the Newton's Third law reaction force 46.

In the first magnetic field sector 32′, the stators 30A-30F are angularly placed around the housing 22, angularly spaced, adjacent to but spaced apart from the housing 22 at increasing distances from the housing outer wall 26, when seen in the clockwise direction. The stator 30F is closest to the housing 22.

In the counterclockwise direction, the stators 30A-30F are located at decreasing distances from the housing outer wall 26, to provide a first magnetic field with an increasing magnetic field in the counterclockwise direction, where the magnetic field is continuous. Except for a predetermined brief moment when the stator 30F turns off the magnetic field; to create a magnetic field break that allows the rotors 44 inside the housing 22 to move away from the stator 30F and first magnetic field sector 32′. Without the magnetic field break, the rotors 44 would stop instead of moving away from the stator 30F.

In the second magnetic field sector 34′; the stators 30G-30L are angularly located, angularly spaced, adjacent to but spaced apart from the housing 22 at increasing distances from the housing outer wall 26, when viewed in the counterclockwise direction. In the second magnetic field sector 34′, the stator 30G is the closest stator to the housing 22.

In the second magnetic field sector 34′, the stators 30G-30L are angularly located, angularly spaced, adjacent to but radially disposed at increasing distances away from the housing outer wall 26 to provide; a continuous magnetic field of decreasing magnetic field intensity in the counterclockwise direction.

### FIG. 6

FIG. 6 is the Propulsion system 48 side view showing the annular housing 22, the housing outer wall 26, the housing cover 28, the magnet stators 30G-30L, and the frame 40.

### FIG. 7

FIG. 7 is a top view of the propulsion system 48 taken along C-C′ in FIG. 6; showing the propulsion system 48 with the housing 22 surrounded by the stators 30A-30F in the first magnetic field sector 32′; and the second magnetic field sector 34′ with the second assembly of stators 30G-30L with permanent magnets. The figure shows the housing 22 with an internal track 42 with a plurality of rotors 44 in counterclockwise motion between the inner wall 24 and the outer wall 26. The first magnetic field sector 32′ and the second magnetic field sector 34′ angular length, of either one or both sectors; is approximately 180° or less.

In the first magnetic field sector 32′, the stators 30A-30F; provide a magnetic field with an increasing magnetic field intensity in the counterclockwise direction; with a magnetic field polarity opposite to the rotors 44 polarity, where the magnetic field is continuous.

In the second magnetic field sector 34′, the stators 30G-30L are angularly located, angularly spaced, adjacent to but apart from the housing 22 at increasing distances from the housing outer wall 26, when viewed in the counterclockwise direction. The stators 30G-30L provide a second magnetic field of decreasing magnetic field intensity in the counterclockwise direction; where the magnetic field is continuous. With a magnetic field polarity; having the same polarity as the rotor 44 magnetic polarity. The magnetic fields interactions between the stators 30G-30L second magnetic field and the rotor 44 magnetic field; is in the magnetic repulsion mode. The housing 22 and the stators 30A-30L are affixed to the frame 40.

### Operation—FIG. 7—Second Embodiment

FIG. 7 shows two sectors in the propulsion system 48; the first magnetic field sector 32′ and the second magnetic field sector 34′propelling a plurality of rotors 44 sliding in the track 42 inside the housing 22. In the first magnetic field sector 32′; the stators 30A-30F provides a first magnetic field with increasing magnetic field intensity in the counterclockwise direction, with a polarity opposite to the rotors 44 magnetic field polarity. The magnetic field interactions between the rotors 44 and the stators 30A-30F magnetic field; are in the magnetic attraction mode. The increasing magnetic field intensity in the counterclockwise direction between the rotors 44 and the stators 30A-30F; generate increasing magnetic field attraction forces that magnetically attract and accelerate the rotors 44 in the counterclockwise direction. The rotor 44 accelerations give the rotors 44 the predetermined angular velocity and the corresponding angular momentum that propel the rotors 44 in the counterclockwise direction. The forces of magnetic field attraction accelerate one or more rotors 44 in the counterclockwise direction; is the stators 30A-30F Newton's Third Law action that accelerates the rotors 44.

At the same time, the magnetic field interactions between the stators 30A-30F and the rotors 44; generate local Newton's Third Law reaction forces in the stators 30A-30F in the clockwise direction. The resultant local reaction forces in the stators 30A-30F; have reaction force components that contribute to the total Newton's Third Law reaction force 46 magnitude and direction.

After magnetic interaction with the stator 30F, the interacting rotor 44; depart the stator 30F and enter the second magnetic field sector 34′ with the predetermined angular velocity, and the angular momentum obtained with the accelerations in the first magnetic field sector 32′. In the second magnetic field sector 34′, the stators 30G-30L generate a second magnetic field of continuously decreasing magnetic field intensity in the counterclockwise direction. The second magnetic field has the same magnetic polarity as the rotors 44 polarity. With the same magnetic polarity for both; the magnetic interactions between the stators 30G-30L second magnetic field and the rotors 44 magnetic fields; is in the magnetic repulsion mode. The magnetic interactions with magnetic repulsion forces; decelerate the rotor 44 to reduce the rotor 44 initial angular velocity to a reduced second angular velocity. The deceleration also decreases the rotor 44 initial angular momentum as the rotors 44 spend angular momentum and energy of motion to overcome the stators 30G-30L second magnetic field repulsion forces that opposes the rotors 44 movement through the second sector 34′. The traffic of one or more rotors 44 in transit through the second magnetic field sector 34′; interact with the stators 30G-30L magnetic field repulsion forces, in a momentum exchange that generate Newton's Third Law reaction forces in the stators 30G-30L. The rotor 44 loses momentum to overcome the magnetic field repulsion forces from the stators 30G-30L magnetic field (momentum conservation).

### Newton's Third Law With Magnetic Field Repulsion

In the second magnetic field sector 34′, the stators 30G-30L and the rotors 44; face each other with the same magnetic field polarity to generate magnetic field repulsion between the same polarity magnetic fields. The oncoming traffic of one or more rotors 44 from the first magnetic field sector 32′; meet the opposing second magnetic field originating in the stators 30G-30L.

The movement of one or more rotors 44 in the track 42; is in the counterclockwise direction. The second magnetic field from the stators 30G-30L; opposes the oncoming rotors 44 movement in order to progressively and incrementally; decelerate the rotors 44 from the oncoming angular velocity from the magnetic field sector 32′, to the reduced second angular velocity in the second sector 34′. The stators 30G-30L magnetic field repulsion force; is the Newton's Third Law action that opposes the movement of the oncoming rotors 44 magnetic fields; and at the same time decelerate and slow down the rotors 44 angular velocity.

With the same polarity magnetic fields interacting against each other, the stators 30G-30L magnetic repulsion forces in opposition to the traffic of the same polarity rotors 44; push against the oncoming rotors 44 magnetic fields in the clockwise direction. The magnetic repulsion forces on the approaching rotors 44; is the stators 30G-30L Newton's Third Law action on the rotors 44. As the Newton's Third Law equal and opposite reaction against the stators 30G-30L second magnetic field; the rotors 44 with their magnetic field, momentum, and kinetic energy of motion; push against the stators 30G-30L magnetic fields in the counterclockwise direction. The magnetic field repulsion of the rotors 44 magnetic fields by the stators 30G-30L second magnetic field; is the Newton's Third Law action that generates on the stators 30G-30L, the reciprocal equal and opposite Newton's Third Law reaction. Multiple rotors 44 imply multiple reaction forces on the stators 30G-30L.

The magnetic field repulsion from the stators 30G-30L magnetic fields comprising the second magnetic field; push against the oncoming rotor(s) 44 magnetic fields as the Newton's Third Law action that simultaneously generate, the required equal and opposite Newton's Third Law reactions in the stators 30G-30L.

In the second magnetic field sector 34′, the stators 30G-30L second magnetic field, pushing against the traffic of oncoming rotors 44 magnetic fields in the clockwise direction; is the Newton's Third Law action. While simultaneously, the traffic of rotors 44 magnetic fields push against the stators 30G-30L magnetic field in the counterclockwise direction as the resultant and consequential Newton's Third Law reaction.

During the rotor 44 journey through the second magnetic field sector 34′, the rotors 44 angular velocity and angular momentum gradually and continuously decreases as the rotors 44 push against the stators 30G-30G second magnetic field. While simultaneously, the rotors 44 spend angular momentum and energy of motion in overcoming the magnetic repulsion forces from the stators 30G-30L. The traffic of one or more rotors 44 traveling through the second magnetic field sector 34′ with the stators 30G-30L second magnetic field; participate in a momentum and energy exchange; that gradually and incrementally reduce the rotors 44 angular velocity and angular momentum. And at the same time generate; directional and localized reaction forces in the stators 30G-30L. While leaving in each of the rotors 44; enough and sufficient left over momentum to propel the rotors 44 to leave the second sector 34′ in order to arrive to the stator 30A in the first magnetic field sector 32′.

In the first sector 32′ and the second sector 34′, the Newton's Third Law reactions in the stators 30A-30L generate reaction forces in the direction that contributes to the reaction force 46 magnitude and direction. FIG. 7 implies that, the stators 30G-30L generate Newton's Third Law reaction forces at an angle in the counterclockwise direction. While the stators 30A-30F; generate Newton's Third Law reaction forces at an angle in the clockwise direction. The stators 30A-30L Newton's Third Law reaction force angle depends on the angular each of each of the stators 30A-30L angular location on the housing 22. The stators 30A-30L angular dependent stator reaction force; generate reaction vector force components in the counterclockwise direction. The stators 30A-30L and the rotor 44 can be implemented with permanent magnets like Neodymium magnets or with electromagnets.

In the propulsion system 48, the resultant Newton's Third Law reaction forces in the stators 30A-30F and in the stators 30G-30L; generate Newton's Third Law reaction vector force components in the same direction. That as a sum of forces; contribute to the total magnitude of the Newton's Third Law reaction force 46. The stators 30A-30L and the housing 22; are attached to the frame 40; and all the stators 30A-30L local reaction forces are communicated to the frame 40 such that, the housing and the stators 30A-30L will be propelled in the same direction as the reaction force 46; in addition to any vehicle to which the frame 40 is attached for propulsion.

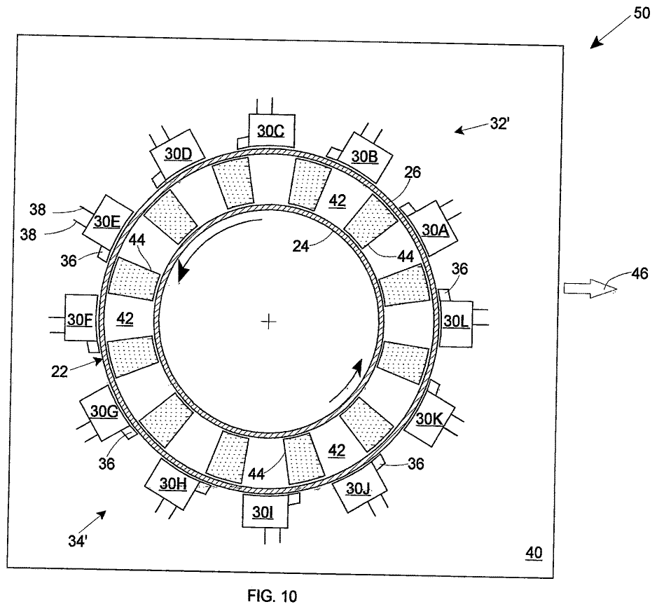

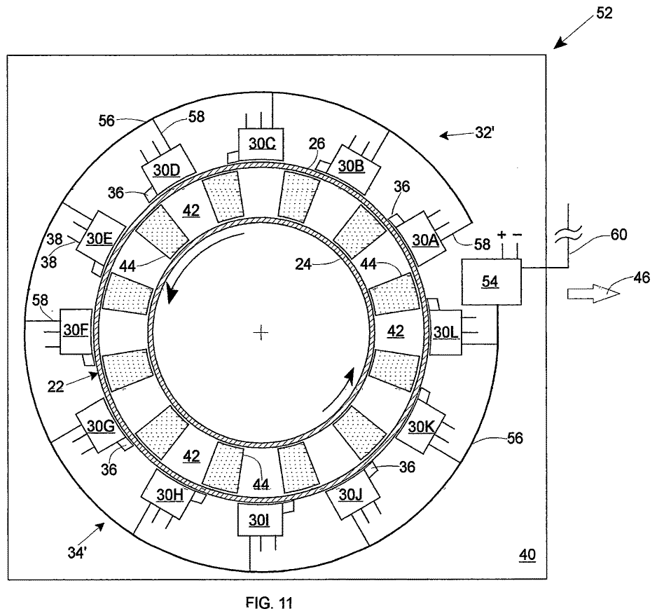

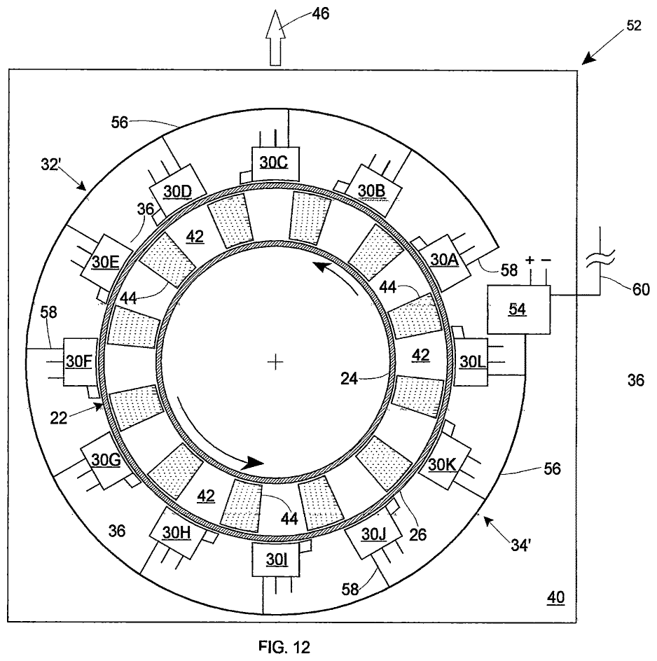

### FIG. 8, FIG. 9 and FIG. 10—Third Embodiment

### FIG. 8

FIG. 8 shows a propulsion system 50 featuring as an improved propulsion system 48. With the improvements comprising the replacement of all the stators 30A-30F in the first magnetic field sector 32′; and the replacement of all the stators 30G-30L in the second magnetic field sector 34′, with similar electric stators comprising electromagnets with sensors 36, and the electric wires 38 for connection to an electric power supply (not shown) to receive the electric energy that generate the magnetic fields. The stators 30A-30L are adjacent to, angularly spaced, angularly located, encircling the annular housing 22 at the same distance from the periphery of the housing 22 outer wall 26.

FIG. 8 shows the housing 22, housing inner wall 24, housing outer wall 26, housing cover 28, first magnetic field sector 32′ comprising the stators 30A-30F, second magnetic field sector 34′ comprising the stators 30G-30L, the frame 40, and the Newton's Third Law reaction force 46.

The first magnetic field sector 32′with an approximate angular length of 180° or less; has one or more stators 30A-30F angularly located around the housing 22, adjacent to, angularly spaced to provide a first magnetic field with an increasing magnetic field intensity in the counterclockwise direction; where the magnetic field is a continuous magnetic field gradient. Except for a predetermined brief moment, when the stator 30F turns off its magnetic field to create a break that allows the rotor 44 to break away from the stator 30F and exit the first magnetic field sector 32′. The stators 30A-30F magnetic field is of the opposite polarity to the rotor 44 polarity. The magnetic field interactions between the stators 30A-30F first magnetic field and the rotors 44; is in the magnetic field attraction mode.

In addition to the sensor 36 being connected alongside each of the stators 30A-30L; the sensors 36 can also be placed in different housing 22 locations to facilitate the detection of the rotor 44 inside the housing 22. The stators 30A-30L in the propulsion system 50; are all electric stators 30A-30L with electromagnets to generate the required magnetic fields with electric energy. All the stators 30A-30L encircling the housing 22; are angularly disposed in specific angular locations, angularly spaced at equal intervals around the housing 22, adjacent to the housing 22 at equal distances from the housing outer wall 26 periphery.

In the first magnetic field sector 32′, the magnetic fields the stators 30A-30F generate; combine as a continuous first magnetic field with an increasing magnetic field intensity in the counterclockwise direction. With a magnetic field polarity which is opposite to the rotors 44 magnetic field polarity. In the first magnetic field 32′ zone, the stators 30A-30F magnetic field; interacts with one or more rotors 44 as an increasing magnetic attraction force in the counterclockwise direction.

In the first magnetic field sector 32′, the magnetic field intensity each of the stators 30A-30F produce; generate the magnetic field that increases sequentially and incrementally in the counterclockwise direction as a magnetic field gradient; starting with the stator 30A with the lower magnetic field intensity, and ending with the stator 30F with the highest magnetic field intensity. The counterclockwise progressive and increasing magnetic field intensity the stators 30A-30F generate; can be expressed as: H_{30A}<H_{30B}<H_{30C}<H_{30D}<H_{30E}<H_{30F}, where “H” refers to magnetic field intensity, and the subscripts refers to each of the stators 30A-30F. In the magnetic field sector 32′, the combined magnetic fields the stators 30A-30F generate; is a continuous first magnetic field in the counterclockwise direction. The stators 30A-30F magnetic field; magnetically attracts and accelerates the rotors 44 in the counterclockwise direction inside the track 42. The rotor 44 movement is in the counterclockwise direction.

Similarly, the magnetic fields each of the stators 30G-30L generate; combine as a continuous second magnetic field of decreasing magnetic field intensity in the counterclockwise direction. With a magnetic field polarity which is of the same polarity as the rotors 44 magnetic polarity. The magnetic fields interaction between the stators 30G-30L second magnetic field and the rotor 44 magnetic field; is in the magnetic repulsion mode.

The second sector 34′ involves; the stators 30G-30L angularly located at predetermined angular positions around the housing 22, angularly spaced at equal intervals, adjacent to the housing 22, where the stators 30G-30L generate the second magnetic field of decreasing magnetic field intensity in the counterclockwise direction. That with the same magnetic polarity as the rotors 44 polarity; generate magnetic field repulsion forces between the rotors 44 and the stators 30A-30F.

In the magnetic field sector 34′, the stators 30G-30L second magnetic field is one continuous field with a progressive and sequentially decreasing magnetic field intensity in the counterclockwise direction. The progressive and decreasing second magnetic field intensity in the magnetic field sector 34′, can be expressed as: H_{30G}>H_{30H}>H_{30I}>H_{30J}>H_{30K}>H_{30L}, where “H” is the magnetic field intensity, and the subscripts refer to the stators 30G-30L. The stator 30G starts with the highest magnetic field intensity H30G, and ends in the stator 30L with the lowest magnetic field intensity H30L. The polarity of the stators 30G-30L; generate the magnetic field repulsion forces that oppose the rotors 44 magnetic fields, to reduce the angular momentum, and reduce the rotors 44 oncoming angular velocity by decelerating the rotors 44 to the predetermined angular velocity that allows the rotor 44 to exit the second magnetic field sector 34′ with the leftover momentum.

### FIG. 9

FIG. 9 is the propulsion system 50 front view, showing the annular housing 22, the housing outer wall 26, the housing cover 28, the stators 30F-30L mounted on the frame 40, several of the sensors 36, and the stator wires 38 for connection to the power supply (not shown).

### FIG. 10

FIG. 10 is a top view of the annular housing 22 taken along D-D′ in FIG. 9; showing the housing inner wall 24, the outer wall 26 surrounded by the stators 30A-30F in the first magnetic field sector 32′ and the stators 30G-30L in the second magnetic field sector 34′. All the stators 30A-30L interact magnetically with one or more rotors 44 in the track 42 inside the housing 22. The stators 30A-30L; each has electric wires 38 to receive electric power from a power supply to generate the required magnetic fields. The one or more rotors 44 accelerate in the magnetic field sector 32′ to a predetermined angular velocity; and decelerate to a predetermined lower angular velocity in the second magnetic field sector 34′. The accelerations decelerations of one or more rotors 44; generate the Newton's Third Law reactions in the stators 30A-30L surrounding the housing outer wall 26 periphery. The housing 22 and the stators 30A-30L are are attached to the frame 40. The vector sum of all the reaction forces in the stators 30A-30L, generate the Newton's Third Law reaction force 46.

### Operation—FIG. 10

The propulsive Newton's Third Law reaction force 46 is the consequential byproduct of the local reaction forces in the stators 30A-30L. The local reaction forces are in response to the accelerations and decelerations of one or more rotors 44; with the magnetic field interactions between one or more rotors 44 interacting with the stators 30A-30L. With magnetic field action, the stators 30A-30L apply the Newton's Third Law action on one or more rotors 44; and the action on the rotors 44 reciprocate with the Newton's Third Law equal and opposite reaction on the stators 30A-30L.

In the first magnetic field sector 32′, the increasing forces of magnetic field attraction in the counterclockwise direction; is the Newton's Third Law action that accelerates the rotors 44 in the counterclockwise direction. The stators 30A-30F magnetic field attraction that accelerate one or more rotors 44 in the counterclockwise direction; is the Newton's Third Law action that also generate, the reciprocal equal and opposite Newton's Third Law reaction in the stators 30A-30L. The Newton's Third Law reactions in the first magnetic field sector 32′, contributes to the total magnitude and direction of the consequential and propulsive Newton's Third Law reaction force 46.

In the second magnetic field sector 34′, the stators 30G-30L and the magnetic fields the stators 30G-30L generate; combine to make a second magnetic field of decreasing magnetic field intensity in the counterclockwise direction. With a polarity which is the same as the rotor 44 magnetic field polarity; causing magnetic repulsion forces between the stators 30G-30L second magnetic field and the rotors 44 magnetic fields. The magnetic field repulsion from the stators 30G-30L second magnetic field; repel and push on the rotor 44 magnetic field in the clockwise direction; and is the Newton's Third Law action that decelerates the rotors 44. And at the same time, generates in the stators 30G-30L; the consequential and reciprocal Newton's Third Law equal and opposite reaction in the clockwise direction.

The stators 30G-30L magnetic fields intensity decreases progressively in the counterclockwise direction. The stators 30G-30L second magnetic field magnetic repulsion force in the clockwise direction; push the oncoming rotors 44 away from the stators 30G-30L with a progressive and diminishing magnetic repulsion force. Causing the progressive deceleration of the rotors 44 by the expenditure of angular momentum in overcoming the magnetic repulsion forces ahead of the rotor 44; while in transit though the second magnetic field sector 34′.

In the magnetic field sector 34′, the deceleration of one or more rotors 44 with the forces of magnetic field repulsion between the rotors 44 and the stators 30G-30L magnetic field; generate additional Newton's Third Law reaction forces that supplement and increases the propulsive Newton's Third Law reaction force 46.

The second magnetic field is a magnetic repulsion field. At the same time, as the rotors 44 move counterclockwise with their momentum and Kinetic energy of motion; with the rotors 44 magnetic fields; the rotor 44 push against the stators 30G-30L magnetic fields in the counterclockwise direction. The magnetic field repulsion interactions between the stators 30G-30L and the traffic of rotors 44 passing through the second sector 34′; generate Newton's Third Law equal and opposite reactions on the stators 30G-30L in the counterclockwise direction. The magnetic repulsion from the stators 30G-30L second magnetic field pushing on the rotors 44 in the clockwise direction; is the Newton's Third Law action that generate in the stators 30G-30L, the corresponding Newton's Third Law equal and opposite reactions in the counterclockwise direction. Upon the rotor 44 arrival of the to the stator 30L, after spending momentum and energy in overcoming the stator 30G-30L second magnetic field repulsion forces, with the left over momentum and energy of motion, the rotors 44 continue in transit toward the next stator 30A to start a new and repetitive propulsive thrust output cycle once again. The movement of the rotor 44 inside the housing 22 is counterclockwise.

With reference to the rotor 44 movements in the counterclockwise direction in the track 42 inside the housing 22; in the first magnetic field sector 32′, the magnetic attraction forces between the rotors 44 and the stators 30A-30F first magnetic field; generate Newton's Third Law reaction forces in the clockwise direction. At the same time, the stators 30A-30F Newton's Third Law reaction forces in the clockwise direction; generate directional vector force components that contribute to the magnitude of the propulsive Newton's Third Law reaction force 46. Additional stators can be added adjacent to the inner wall 26.

In the second magnetic field sector 34′, the magnetic repulsion forces between the rotors 44 and the stators 30G-30L magnetic fields; generate in the stators 30G-30L, Newton's Third Law reaction forces in the counterclockwise direction. The simultaneous counterclockwise reaction forces in the stators 30G-30L generate; directional vector force components that also contribute to the total magnitude of the Newton's Third Law reaction force 46.

FIG. 10 shows that the first magnetic field sector 32′ and the second magnetic field sector 34′; have angular lengths of approximately 180° or less, and occupy opposite sides on the housing 22. Inside the housing 22, the movement of one or more rotors 44 is in the counterclockwise direction (indicated with two arrows). In the first sector 32′, the Newton's Third Law reaction forces on the stators 30A-30F are in the clockwise direction. In the housing 22 opposite side, in the second sector 34′; the resultant Newton's Third Law reaction forces have on the stators 30G-30L indicate on orientation in the counterclockwise direction. Each of the stators 30A-30L have an angular position on the housing 22. Giving the reaction forces on the stators 30A-30L the corresponding angular orientation that generate reaction vector force components. In the first sector 32′, the stators 30A-30F Newton's Third Law reaction forces indicate the clockwise direction. While in the second sector 34′, the stators 30G-30L Newton's Third Law reaction forces indicate the counterclockwise direction. Both sectors 32′ and 34′ produce Newton's Third Law reaction vector forces in the same direction.

The vector summations of all the local Newton's Third Law reaction vector force components in the same direction; generate the forces that propels the frame 40 and any vehicle to which the frame 40 is attached to, in the same direction as the direction of the Newton's Third Law reaction force 46.

In the operation that generates propellantless thrust, the magnetic field is the source of energy that generates the Newton's Third Law action that accelerates and decelerates one or more rotors 44; and at the same time, generates the corresponding equal and opposite Newton's Third Law reactions that make up the Newton's Third Law reaction force 46.

### FIG. 11—Fourth Embodiment

FIG. 11 shows the propulsion system 50 as an improved propulsion system 52. With the improvement comprising the addition of a microcontroller 54 with a wire harness 56 for connection to all the stator 30A-30L by way of a stator signal conductor 58 from the harness 56; to communicate control signals from the microcontroller 54 to all the stators 30A-30L, or to any specific stator or any selected number of stators in the stators group 30A-30L. A control signal harness 60; receives thrust and direction control signal instructions from the vehicle control station and transfer the instructions to the microcontroller 54. The control station is located in the vehicle on which the propulsion system 52 in attached to for propulsion. The microcontroller 54 translates the signal instructions to operate the stators 30A-30L. The control signals are in the form of instructions for the amount of electric energy each of the stators 30A-30L get from the electric power supply. To generate the magnetic field with the proper magnetic field polarity, magnetic field intensity, time duration, changes to the reaction force 46 direction, and to increase or decrease the reaction force 46 magnitude.

### FIG. 12

FIG. 12 exemplifies the propulsion system 52 adeptness to redirect the reaction force 46 in any new direction. The system 52 receives the instructions to redirect the reaction force 46 by ninety degrees (90°) counterclockwise. The control station is located in the vehicle on which the propulsion system 52 is attached to for propulsion. Vehicles such as, military combat and troops transport airplanes, commercial airliners, and spaceships operating high in the atmosphere, in orbit, and in the vacuum of space for space travel.

To change the force 46 direction, the first magnetic field sector 32′, where the rotor 44 acceleration take place; change to the group of stators 30C, 30D, 30E, 30F, 30G and 30H. In the second magnetic field sector 34′ where the rotor 44 deceleration take place; change to the group of stators 301, 30J, 30K, 30L, 30A, and 30B. The acceleration of one or more rotors 44 in the first magnetic field sector 32′; generates the essential and corresponding Newton's Third Law reaction forces in the stators 30C-30H.

Simultaneously, the deceleration of one or more rotors 44 in the second magnetic field sector 34′; generates the essential Newton's Third Law reaction forces on the stators 30I, 30J, 30K, 30L, 30A, and 30B to comprise part of the reaction force 46. Therefore, the exemplification shows the Newton's Third Law reaction force 46 can be redirected in any chosen direction. As well as controllable adjustments in the magnetic field magnitude by changing the magnetic field intensity the stators 30A-30L generate; by changing the amount of electric energy each of the stators 30A-30L can receive from the power supply.

There are 12 electric stators 30A-30L suggesting there are at least twelve possible vector force directions in which the reaction force 46 can be redirected. This propulsive capability and usefulness opens up multiple possibilities for directional maneuverability and thrust control in the air, ground, water, and in the vacuum of space; by redirecting the Newton's Third Law reaction force 46 in any direction.

In the vertical and horizontal orientations, the propulsion system 52 capabilities to change the reaction force 46 in multiple directions; is useful for spacecraft attitude and thrust control in all 360° vertical and horizontal directions. In the aerospace environment, a pilot can exercise aircraft lift and thrust control in any direction.

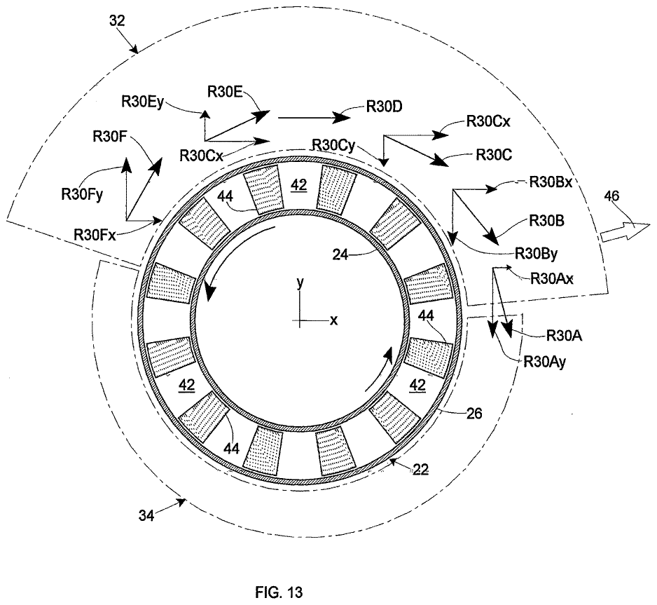

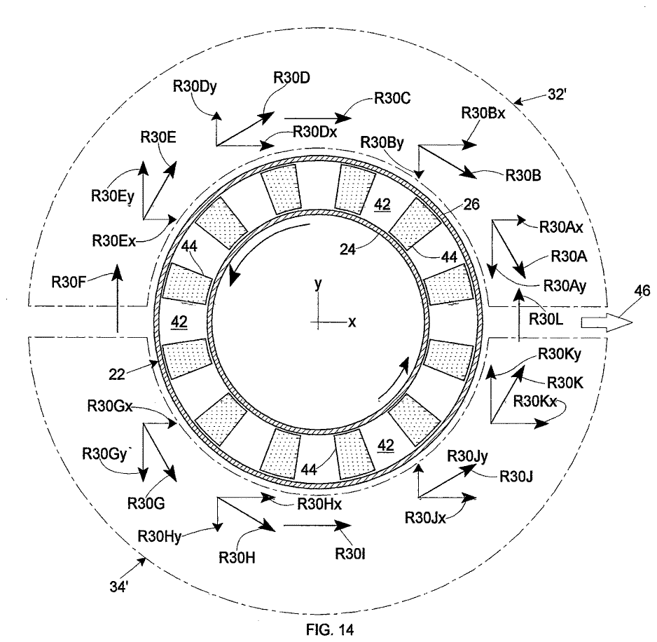

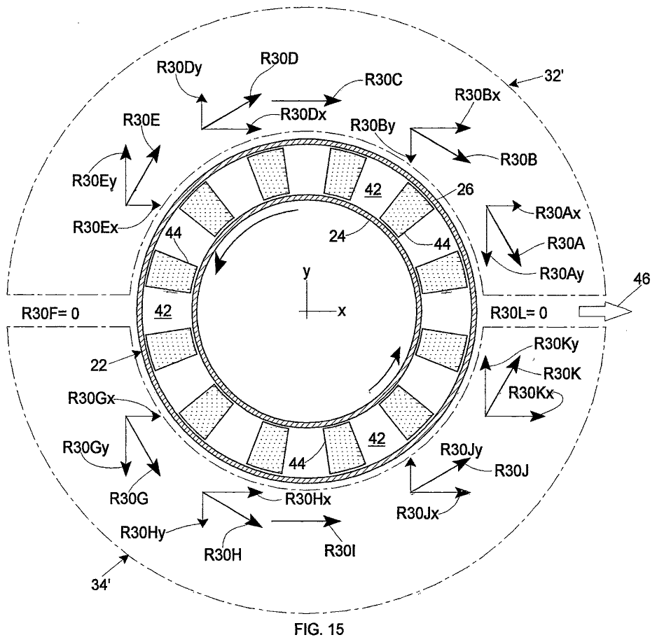

### FIG. 13, FIG. 14, and FIG. 15

FIGS. 13, 14, and 15 are visual summaries that show the vector force components the local reaction forces the stators 30A-30L (R30A-R30F) generate in the magnetic field sectors 32, the first magnetic field sector 32′, and in the second magnetic field sector 34′. The figures show; the stators 30A-30L angular dependent positions on the housing 22; and the local Newton's Third Law reaction force each stator 30A-30L generate. The principal reaction force (R) originates in the stator; generate local x and y reaction vector force components (Rₓ, R_{y}) relative to the central (x, y) coordinate system. The sum of all the stators 30A-30L directional reaction vector force components from each stator; go on to comprise the Newton's Third Law reaction force 46. The stators around the housing 22 are not shown, instead; the stators 30A-30L are replaced with the Newton's Third Law reaction forces the stators produce during operation. The stators 30A-30L generate Newton's Third Law reaction forces expressed as Rn for the stator number, and the vector force components of the force as Rnₓ and Rn_{y}.

### FIG. 13

FIG. 13 shows the propulsion system 20, the housing 22, the housing inner wall 24, housing outer wall 26, the magnetic field sector 32, the second sector 34, the track 42 with a plurality of rotors 44. The stators 30A-30F; are replaced with local Newton's Third Law reaction forces each of the stators 30A-30F produce. The rotors 44 sliding movement in the track 42 is in the counterclockwise direction. FIG. 13 displays the principal and the Newton's Third Law local reaction forces produced in the magnetic field sector 32. And the vector force directions each of the stators 30A-30F generate in the magnetic field sector 32.

Each stators 30A-30F (R30A-R30F) has a local inclination angle dependent on the stator angular location around the housing 22. The stators 30A-30F are; angularly positioned between the 0° and the 180° angular position on the housing 22 outer side. The central (x, y) coordinates are shown in the drawing as a reference for the visual determination of the resultant vector force components in the x and y directions. FIG. 13 shows that, the stators 30A-30F each generate one principal Newton's Third Law reaction force with the angle of inclination that correspond to the particular stator angular position about the housing 22. The stator principal reaction force R generates local reaction vector force components Rₓ and R_{y} in the x and y directions. The sum of all the local reaction vector force components form the stators 30A-30H; make a vector sum of forces. The stators 30A-30F vector sum of all the local reaction forces, comprise the forces that make the Newton's Third Law reaction force 46 at an angle of inclination as FIG. 13 stipulates. Those skilled in the art are familiar with vector mechanics and are capable of performing the required calculations.

### FIG. 14

FIG. 14 shows the reaction forces present in the first magnetic field sector 32′ and in the second magnetic field sector 34′. FIG. 14 shows the housing 22, the inner wall 24, the outer wall 26, the track 42 with the plurality of rotors 44 inside, and the Newton's Third Law reaction force 46. The stators 30A-30L are not shown but instead; replaced with the Newton's Third Law reaction forces each of the stators 30A-30L generate in each magnetic field sector.

Each stator (R30A-R30L) originated Newton's Third Law reaction force Rn generates the stator dependent vector force components Rnₓ and Rn_{y} in the x and y directions.

FIG. 14 illustrates that, the first magnetic field sector 32′ shows the local reaction force R each of the stators 30A-30F generates; with the corresponding reaction vector force components of the force (Rₓ and R_{y}).

In the first magnetic field sector 32′; the magnetic interactions between the rotor 44 and the stators 30A-30F first magnetic field happen with magnetic attraction. In the first magnetic field sector 32′, as the Newton's Third Law action; the stators 30A-30F (R30A-R30F) generate the first magnetic field with an increasing magnetic field attraction force in the counterclockwise direction. The first magnetic field magnetically attracts and accelerates the rotors 44 in the counterclockwise direction; as the counterclockwise Newton's Third Law action. Reciprocally, the Newton's Third Law action on the rotors 44; generate in the stators 30A-30F, the reciprocal equal and opposite Newton's Third Law reaction in the clockwise direction. That clockwise reaction Rn generates; the two reaction vector force components (Rnₓ and Rn_{y}) shown with arrows in FIG. 14. The vector sum of all the local reaction forces that originate in the stators 30A-30F in the magnetic field sector 32′; go on to make a contribution to the total magnitude and direction that comprise the Newton's Third Law reaction force 46. In FIG. 14, the second magnetic field sector 34′ shows the local reactions forces (R30G-R30L) produced with the magnetic field repulsion interactions between the rotors 44 and the stators 30G-30L. In the second magnetic field sector 34′; the stators 30G-30L generate the second magnetic field with decreasing magnetic field intensity in the counterclockwise direction. In the second magnetic field sector 34′, the stators 30G-30L second magnetic field with the same polarity as the counterclockwise oncoming rotor 44; magnetically oppose with magnetic repulsion forces the rotor 44 magnetic field with the same polarity; by applying on each rotor 44 the force of magnetic repulsion in the clockwise direction. The second magnetic field repulsion forces in the clockwise direction; is the stators 30A-30L Newton's Third Law action on the rotors 44. Reciprocally, the Newton's Third Law action on the rotor 44; generate in the stators 30A-30L the reciprocal Newton's Third Law reaction in the clockwise direction. As FIG. 14 shows with vector arrows, the Newton's Third Law action on the rotors 44; generate Newton's Third Law reactions on the stators 30G-30L in the counterclockwise direction. These reaction vector force components of force go on to become part of the total magnitude of the Newton's Third Law reaction force 46.

In the first magnetic field sector 32′, the arrows representing the stators 30A-30F Newton's Third Law reaction force direction; indicate the clockwise direction. Similarly, in the second magnetic field sector 34′, the arrows representing the stators 30G-30L Newton's Third Law reaction force direction; indicate the counterclockwise direction. However, the stators 30A-30L in both sectors generate reaction vector force component in the same x direction.

Hence, the sum of all the reaction vector force components in the first magnetic field sector 32′and the second magnetic field sector 34′; combine to determine the magnitude and direction of the consequential Newton's Third Law reaction force 46.

### FIG. 15

FIG. 15 is the propulsion system or 52 with only ten (10) stators in operation. The propulsion system 50 or 52 operates with a total of ten (10) stators in operation. In the first magnetic field sector 32′, the stators 30A-30E generates the stator reaction forces that contribute to the thrust output of the system. In which case, the stator 30E performs the function of creating the brief magnetic field break that allows the rotor 44 to continue in transit toward the second magnetic field sector 34′.

In the second sector 34′, the stators 30G-30K generate the reaction forces to also contribute to the reaction force 46. The stator 30F and the stator 30L do not generate any magnetic fields and therefore no reaction forces to contribute to the thrust for propulsion (R30F=0, R30L=0). This is another way to operate the disclosed propulsion system by choosing which stators 30A-30L or which group of stators will be energized to generate the local reaction forces that combine to generate thrust for propellantless propulsion.

### CONCLUSIONS, RAMIFICATIONS, AND SCOPE

The disclosed embodiments show a novel propulsion system that generates propellantless thrust with the Newton's Third Law action and reaction by way of the magnetic field interactions; between the magnetic fields of one or more stators, interacting with the magnetic fields of one or more rotors.

One embodiment shows the magnetic field with one or more stators; interacting with the magnetic fields of one or more rotors. Additional embodiments show; a first magnetic field and a second magnetic field from one or more stators; interacting with the magnetic fields of one or more rotors to produce propellant-less thrust.

The disclosed propulsion systems are useful for the propulsion of vehicles on land, water, in the air, and in the vacuum of space, to keep satellites in orbit, and for space travel. Hence; forget propellers, forget jet engines, and forget the rockets, space travel and flying cars work best with propellantless thrust.

New and novel embodiments can be derived from the variations, derivatives, and permutations based on the teachings and operations described. The invention has been shown in detail. The disclosed propulsion system is not limited to those embodiments. Modifications beyond the disclosed embodiments can be made without departing from the spirit and scope of the invention, as expressed and defined in the following claims.

1-15. (canceled)

16. A propulsion system comprising:
an annular housing with an internal annular track,
one or more rotors for movement in said track,
a magnetic field sector comprising one or more stators angularly disposed angularly spaced adjacent to but apart from said housing at increasing distances from said housing outer periphery when viewed in the clockwise direction, wherein said stators provide a magnetic field of increasing magnetic field intensity when viewed in a counterclockwise direction, wherein said magnetic field is continuous,
at least one stator in said magnetic field sector is an electromagnet adjacent to said housing outer periphery, generating a magnetic field that briefly turns off to create a magnetic field break that allow said rotors in transit through said magnetic sector to continue moving forward,
a second sector comprising a predetermined segment of said track to allow the traffic of said rotors to continue in transit to return to said magnetic field sector.

17. The propulsion system in claim 16 wherein one or more stators comprising

18. The propulsion system in claim 16 wherein said rotors comprising permanent magnets.

19. The propulsion system in claim 16 wherein said rotors comprising electromagnets.

20. A propulsion system comprising:
an annular housing comprising an annular track,
one or more rotors for movement in said track,
a first magnetic field sector comprising one or more stators angularly disposed angularly spaced adjacent to but apart from said housing at increasing distances from said housing outer periphery when viewed in the clockwise direction, wherein said stators provide a first magnetic field of increasing magnetic field intensity when viewed in a counterclockwise direction in which said magnetic field has a polarity opposite to said rotor polarity, wherein said first magnetic field is continuous,
said first sector comprising at least one stator comprising an electromagnet, wherein said electromagnet stator is located adjacent to said housing,
a second magnetic field sector comprising one or more stators angularly disposed angularly spaced adjacent to but apart at increasing distances from said housing outer periphery when viewed in the counterclockwise direction, wherein said stators provide a second magnetic field of decreasing magnetic field intensity when viewed in a counterclockwise direction in which said second field has the same polarity as said rotors polarity, wherein said second magnetic field is continuous.

21. The propulsion system in claim 20 wherein said stators comprising permanent magnets.

22. The propulsion system in claim 20 wherein said rotors comprising permanent magnets.

23. The propulsion system in claim 20 wherein said rotors comprising electromagnets.

24. A propulsion system comprising:
an annular housing comprising an internal track,
one or more rotors for movement in said track,
a first magnetic field sector comprising one or more stators angularly disposed angularly spaced adjacent to said housing wherein said stators provide a first magnetic field of increasing magnetic field intensity when viewed in a counterclockwise direction with a magnetic polarity opposite to said rotors polarity, wherein said first field is continuous,
a second magnetic field sector comprising a one or more stators angularly disposed angularly spaced adjacent to said housing generating a second magnetic field of decreasing magnetic field intensity when viewed in a counter clockwise direction with a polarity which is the same as said rotors polarity, wherein said second magnetic field is continuous.

25. The propulsion system in claim 24 wherein said stators comprising permanent magnets to generate said magnetic fields to interact magnetically with said rotors in said track.

26. The propulsion system in claim 24 wherein said stators comprising electromagnets to generate said magnetic fields to interact magnetically with said rotors in said track.

27. The propulsion system in claim 24 wherein said rotors comprising permanent magnets to generate said magnetic fields to interact magnetically with said rotors in said track.

28. The propulsion system in claim 24 wherein said rotors comprising electromagnets.

29. The propulsion system in claim 24 comprising a microcontroller to select the group of stators comprising said first magnetic field sector and the group of stators comprising said second magnetic field sector.

30. The propulsion system in claim 24, wherein said stators cooperate with a microcontroller to control and monitor the stators magnetic field strength magnetic field polarity and propulsion force direction.
